(19) United States
(12) Patent Application Publication
(10) Pub. No.: US 2006/0214074 A1
(43) Pub. Date: Sep. 28, 2006

(54) Table mounted or supported purse hanger

(76) Inventor: Hany Daoud, Fountain Valley, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 11/088,126

(22) Filed: Mar. 23, 2005

(51) Int. Cl. F16B 45/00; A41H 5/00

(52) U.S. Cl. 248/304; 248/914; 223/120

(57) ABSTRACT

A purse hanger has a base with a top surface tapered downwardly toward opposing ends. An upright portion is positioned medially on the base and extends upwardly to join a pair of opposing C-shaped arms. The arms are integral with the upright portion and extend upwardly further. The arms are spaced apart to form a gap adequate for inserting a strap of a purse. Each of the arms terminates with a flange directed toward the base.

### BACKGROUND OF THE INVENTION

1. Related Applications

none

2. Field of the Invention

This invention relates generally to clamps and brackets and more particularly to a purse hanger that may be placed on the top surface of a table, or may be fastened to the underside surface of the table, and which has a means for engaging a strap of a purse so that the purse may be easily removed but will not fall off the hanger or be easily grabbed from the hanger.

3. Description of Related Art

The following art defines the present state of this field and each U.S. disclosure is hereby incorporated herein by reference:

Rohrmuller, U.S. Des. 244883, discloses an ornamental design for a purse hanger or similar article.

Olson, U.S. Des 300882, discloses an ornamental design for a purse hanger or the like.

Doran, U.S. Pat. No. 2,516,760, discloses a glove holder having a pair of jaws, a means to pivot said jaws together, said jaws having contacting ends and shaped to conjointly form a glove receiving hollow between them, each jaw having an arm on the other side of the pivot means for manipulation of the jaws, one arm having an area to rest upon the upper surface of a shelf or table and the other arm spaced from and beneath it, and a means to attach an article to said second arm to act as a weight by which gravity acts to hold the first arm in contact with the shelf or table.

Zezula, U.S. Pat. No. 3,376,006, discloses a suspension clamp device comprising: a first member having a first clamping jaw extending therefrom, a second member in sliding relation with the first member and having a second clamping jaw extending therefrom, pulley means on the second member, and a cord extending from a point of attachment on the first member upwardly about said pulley means and downwardly therefrom with a depending end portion, whereby upon suspension of an article from said depending cord end portion the first and second clamping jaws are urged toward each other to clamp about a support to suspend the article from the support.

Serkez, U.S. Pat. No. 4,118,001, discloses a handbag holder that folds into a compact form smooth and free of surface projections. A flat region is provided for messages. Folding support and hook arms are fitted snugly with light friction so as not to come open unless intended. Ears on the arms are flush with the body when closed, and may be grasped for opening. When open, the support arm has a rubber friction foot for resting on a table, and the hook arm is grooved to receive the strap of the handbag.

Serkez, U.S. Pat. No. 4,210,302, discloses a handbag holder that folds into a compact form smooth and free of surface projections. A flat region is provided for messages. Folding support and hook arms are fitted snugly with light friction so as not to come open unless intended. Ears on the arms are flush with the body when closed, and may be grasped for opening. The support arm is fixed with a swivel top having a rubber friction foot for resting on a table, and the hook arm is grooved to receive the strap of the handbag. The support arm is movable relative to the swivel top so as to permit the handbag holder to be used on tables with a thick ledge or top.

Weber, U.S. Pat. No. 4,312,455, discloses a holding device for supporting articles such as handbags, newspapers and packages underneath a table top in a dining area, the device being provided with a pivotal attachment which can be secured to any vertical surface underneath a table or to an under-surface of the table top. The holding device is provided with one or more holding members which are pivotally supported to make the holding members more adaptable for supporting the articles whether the holding device is secured from a vertical or a horizontal table surface. The pivotal attachment may possess a reticulated construction adapted for attachment to an arcuate table surface.

Neuman, U.S. Pat. No. 6,345,796, discloses an assembly for suspending a purse or bag from a table edge. The assembly includes a mechanism for automatically anchoring itself to the table edge as it is positioned about the table edge. In addition, the inventive assembly is constructed so as to distribute the weight of the purse or bag to primary support elements. A hook depends downwardly from a bracket to support a bag or purse. The hook includes a flange seated within an opening of the bracket. The flange transfers at least some of the weight of the bag or purse to the bracket. A rivet co-joins the bracket, hook and anchoring mechanism together, and permits rotational movement of the hook relative to the bracket.

Lo, U.S. Pat. No. 5,594,419, discloses a table-edge hanger having a hook for hanging a personal item such as a purse or a jacket. The hook may be movably attached so it can swing side to side. The hanger can also have a decorative attachment which can be a timepiece for keeping time. Preferably, the hanger has a microswitch for triggering an alarm if the personal item is removed from the hook or removed from the table together with the hanger. The alarm can be disabled with an on/off switch if desired.

Bolton, U.S. Pat. No. 3,773,288, discloses a C-shaped rod member that includes upper and lower portions interconnected by a right portion. The upper and lower portions through transversely extending rod portions engage the top and bottom surfaces of a support. The upper portion extends upwardly and outwardly merging into a shoulder, which in turn merges into an outwardly extending ledge on which, the straps of a purse or the like may be supported. The ledge then merges into the upper end of the bight portion.

Pizzirusso, U.S. Pat. No. 6,530,548, discloses a method and apparatus that are used to hang a purse from a piece of furniture, such as a table top. The apparatus comprises a base and a bracket having a first end and a second end. The base can be fixed to the first end of the bracket. The bracket can be positioned on the edge of a piece of furniture, such as a table top, so that the base sits on a top surface of the piece of furniture and a strap can be hung from the second end of the bracket. The base may have a base with a bottom surface which contacts the top surface of the table top when the bracket is positioned on the edge of the table top. The bracket may include a rim at the second end of the bracket and a portion connected to the rim, wherein the rim has a larger diameter than the portion, so that the strap placed over the portion will be prevented from falling off of the bracket.

Berardinelli et al., U.S. Pat. No. 3,860,210, discloses a holder for a handbag for use in hanging the handbag in a suspended position from a table, counter, shelf or the like and including a clamp-like member to which a surface engaging arm is pivotally joined to one end thereof and a bag support portion is pivotally joined to another end thereof, the arm and support portion being movable from a closed to an open position for mounting the holder on a horizontal surface wherein the handbag is suspended from the holder in a stored position.

Kennedy, U.S. Pat. No. 4,978,093, discloses a purse hanger that comprises a connecting member with a rigid flange at one end to secure the purse hanger to a table and with a hook or other retaining means at the other end to hold a purse. The purse hanger is designed to be used with a gaming table that has a padded surface and a cushioned raised rim that rests on the edge portion of the gaming table. The connecting member conforms to the shape of the exterior surface of the raised rim and the rigid flange is slidably mounted between the top of the table surface and the bottom of the raised rim. An alternate embodiment of the purse hanger has a rigid tapered flange with a rigid hook attached directly thereto which is particularly useful for purses with long straps.

Catan, U.S. 2003/0038220, discloses a utility hook that holds a handbag under a table. The hook includes a hanger that hangs from foot linked by a pivot joint with at least one axis of freedom. The part of the hook from which the strap of the handbag may be hung is located directly below the axis of pivot in such a way as to naturally align the hanger with a minimum of extension beyond the table. The foot may be rotated to align its major plane with that of the hanger to form a compact arrangement.

Weitzman, U.S. 2004/0108432, discloses a hook-like holder to enable purses to be hung from tables or other flat surfaces to avoid their placement on floors, tables, or uncomfortably in laps. The holder has an adjustability feature to enable its use on different types of structures. The top portion is ornamental in nature, to provide a pleasing and in fact conversational effect.

Sidelman, U.S. 2004/0118989, discloses a device for suspending an object from the surface of a support, that comprises a first leg adapted to abut the support surface, and a second leg being connected to the first leg so that the first leg is oriented at an angle with respect to the second leg. A hook is connected to the first leg and is adapted to be releasably attached to the object and, when the first leg is disposed on the support surface, the hook lies beneath the first leg, so that the weight of the object exerts a force on the first leg toward the support surface.

Creed, U.S. Pat. No. 5,094,417, discloses improvements in devices for receiving, hanging and supporting purses, handbags and other strap carried containers on the edge of a table, desk or other support; portable hanger devices for purses, handbags and the like able to engage the periphery of a table, desk or other support and receive therewithin the straps of a purse or handbag in such a manner as to support it in at least two optional positions, thus enabling free support of the container, handbag or purse in either crowded or open conditions around the table or desk.

Feuillie, WO 03/047400, discloses a device that is intended for hanging accessories, such as, handbags comprising a handle, from a table top or similar element. The inventive device comprises: a metal wire which is curved at a first end thereof in order to form a support element that can rest on the table top; and an essentially vertical rod, the lower end of which is curved in the direction of the support element in order to form a hook. The invention is characterized in that the free end of said hook is curved in the direction of the vertical rod in order to form a clasp element. Closing means, which extend out from the free end of said clasp element, can be used, together with the vertical rod, to close the hook.

Our prior art search with abstracts described above teaches handbag holders with a wide range of features. Those holders for engaging a handbag on or under a table provide means for engaging the handbag and means for supporting the handbag once engaged. However, the present invention distinguishes over the prior art handbag holders in that it along provides a simple extrudable shape having two upright, facing, C-shaped arms providing a gap between them for inserting a handbag strap, and tapered base for insertion under a table cushion as described in the following summary.

### SUMMARY OF THE INVENTION

The present invention teaches certain benefits in construction and use which give rise to the objectives described below.

In a best mode preferred embodiment of the present invention, a purse hanger, a base with a top surface is tapered downwardly toward opposing ends. An upright portion is positioned medially on the base and extends upwardly to join a pair of opposing C-shaped arms. The arms are integral with the upright portion and extend upwardly further. The arms are spaced apart to form a gap adequate for inserting a strap of a purse. Each of the arms terminates with a flange directed toward the base.

A primary objective of the present invention is to provide an apparatus and method of use of such apparatus that yields advantages not taught by the prior art.

Another objective of the invention is to be able to engage a purse at a table side such as in a gambling casino.

A further objective of the invention, a purse hanger, is to prevent the purse from being easily grabbed or yanked away from the hanger.

A still further objective of the invention is to enable the hanger to be inserted under a table edge cushion where it will be held and supported.

Other features and advantages of the embodiments of the present invention will become apparent from the following more detailed description, taken in conjunction with the accompanying drawings, which illustrate, by way of example, the principles of at least one of the possible embodiments of the invention.

### BRIEF DESCRIPTION OF THE DRAWINGS

The accompanying drawings illustrate at least one of the best mode embodiments of the present invention. In such drawings:

FIG. 1 is a perspective view of one embodiment of the invention; and

FIG. 2 is a vertical section taken through two of the present invention and a table, one positioned upright and resting on the top of the table, the other inverted and fastened to an underside surface of the table; this figure further depicting a third one of the present invention positioned upright on the table, not positioned in the cutting plane and as seen from one end thereof.

### DETAILED DESCRIPTION OF THE INVENTION

The above described drawing figures illustrate the present invention in at least one of its preferred, best mode embodiments, which is further defined in detail in the following description. Those having ordinary skill in the art may be able to make alterations and modifications in the present invention without departing from its spirit and scope. Therefore, it must be understood that the illustrated embodiments have been set forth only for the purposes of example and that they should not be taken as limiting the invention as defined in the following.

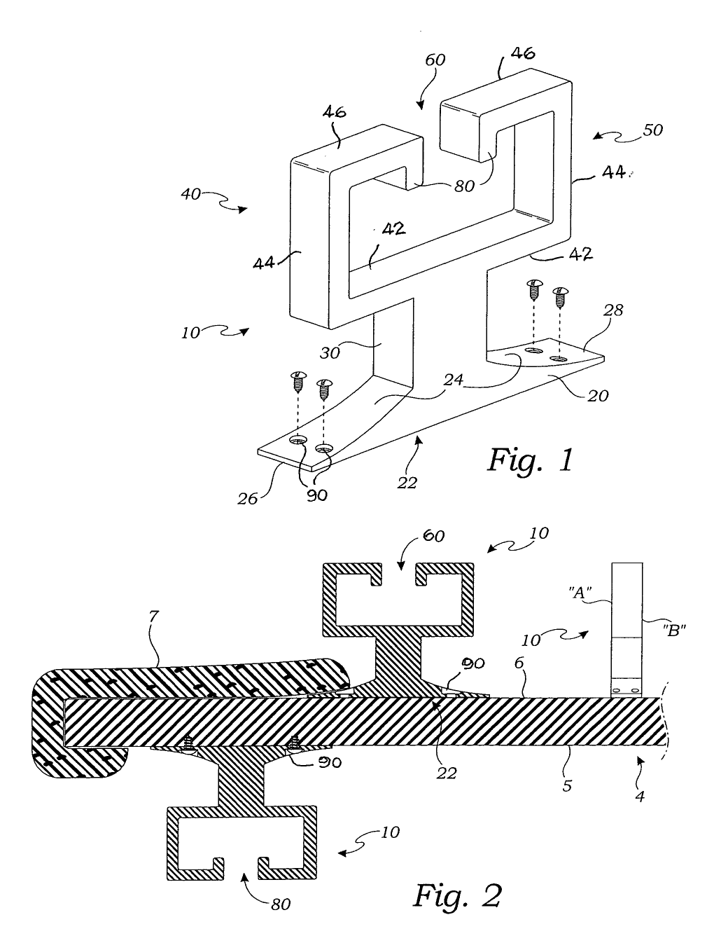

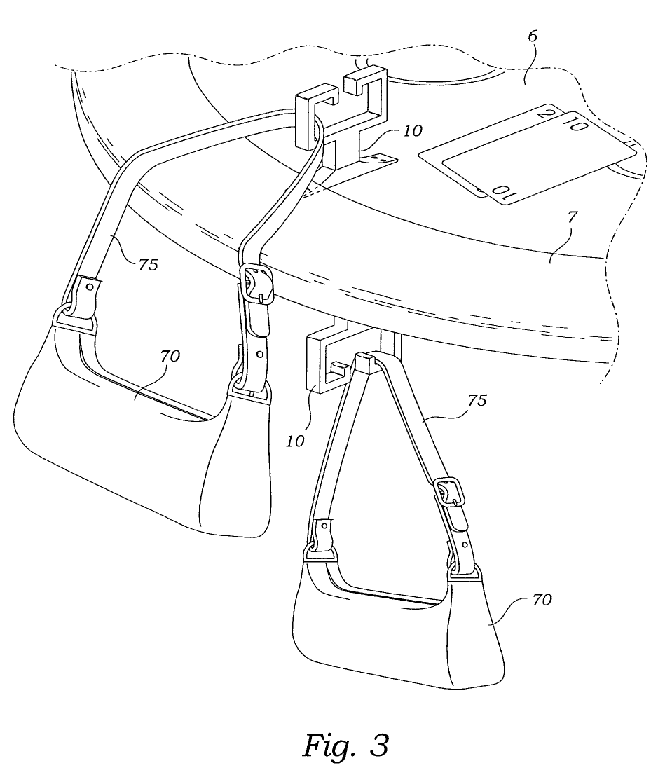

The present invention, as shown in FIGS. 1 and 2, is a purse hanger apparatus 10. In the preferred embodiment of this purse hanger apparatus 10, a base 20 has a flat bottom surface 22 and a top surface 24 tapered downwardly at opposing ends 26 and 28 of the base 20 toward the bottom surface 22. An upright portion 30 is positioned medially on the base 20 and extends upwardly therefrom. A pair of opposing C-shaped arms 40 and 50 are integral with the upright portion 30 and extend upwardly therefrom. The arms 40 and 50, are spaced apart to form a gap 60 between them, and this gap 60 is adequate for inserting a strap 75 of a purse 70. Each of the arms 40 and 50 terminate with a flange 80 which is directed toward the base 20.

Clearly, the upright portion 30 may be eliminated from the present invention when the arms 40 and 50, need not have significant clearance above a table top surface and when the base may extend laterally such that mounting hardware may be inserted without interference with the lowered arms 40 and 50.

At least one, and preferably four clearance through holes 90 are formed in the base 20 for mounting the base 20 to a surface 5, as shown in FIG. 2.

Preferably, the base 20, upright portion 30 and arms 40 and 50 are extensive and sandwiched between two opposing parallel planar surfaces “A” and “B” which are shown in FIG. 2 at the right.

In use, as seen in FIG. 2, the present invention 10 may be positioned in an upright attitude and rested on a top surface 6 of table 4. In this manner, the base 20 may be positioned under a table edge cushion 7 which is able to maintain the invention in its upright attitude and also prevent the invention from being dragged to the edge of the table 4 when a purse 70 is engaged with it as shown at left in FIG. 3.

Alternately, also as seen in FIG. 2, the present invention 10 may be inverted and fastened to the underside surface 5 of the table 4. Again, a purse 70 may be hung from the present invention 10 as shown.

It has been found that the flanges 80 prevent the purse strap 75 from being easily jerked or yanked from the hanger 10 and also prevent the strap 75 from easily falling through the gap 60 when the purse 70 is suspended from the hanger 10 under the table 4.

The hanger 10 is preferably formed as an extruded part and sliced into individual hangers using two parallel cuts from the extrusion along surfaces “A” and “B.” In this manner, the present invention may be manufactured from metal or plastic materials at very low cost.

The enablements described in detail above are considered novel over the prior art of record and are considered critical to the operation of at least one aspect of one best mode embodiment of the instant invention and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or elements of the embodiments of the herein described invention and its related embodiments not described are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the invention and its various embodiments or that a single element may be substituted for two or more elements in a claim.

Changes from the claimed subject matter as viewed by a person with ordinary skill in the art, now known or later devised, are expressly contemplated as being equivalents within the scope of the invention and its various embodiments. Therefore, obvious substitutions now or later known to one with ordinary skill in the art are defined to be within the scope of the defined elements. The invention and its various embodiments are thus to be understood to include what is specifically illustrated and described above, what is conceptually equivalent, what can be obviously substituted, and also what essentially incorporates the essential idea of the invention.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

1. A purse hanger apparatus comprising: a base having a top surface; an upright portion positioned medially on the base and extending upwardly therefrom; and a pair of opposing C-shaped arms, the arms integral with the upright portion and extending upwardly therefrom; the arms spaced apart to form a gap adequate for inserting a strap of a purse, each of the arms providing, in sequence, a linear first horizontal portion integral with the upright portion, a linear vertical portion extending upwardly from the first horizontal portion, and a linear second horizontal portion extending away from the vertical portion, the second horizontal portion terminating with a flange directed toward the base.

2. The apparatus of claim 1 further comprising at least one clearance through hole in the base for mounting the base to a surface.

3. The apparatus of claim 1 wherein the base, upright portion and arms are extensive between, and therefore define, two opposing parallel planar surfaces.

4. A purse hanger apparatus comprising: a base having a top surface; and a pair of opposing arms extending upwardly from the base; the arms spaced apart to form a gap adequate for inserting a strap of a purse therethrough, each of the arms providing, in sequence, a linear first horizontal portion integral with the upright portion, a linear vertical portion extending upwardly from the first horizontal portion, and a linear second horizontal portion extending away from the vertical portion, the second horizontal portion terminating with a flange directed toward the base.

5. The apparatus of claim 4 further comprising at least one clearance through hole in the base for mounting the base to a surface.

6. The apparatus of claim 4 wherein the base, upright portion and arms are extensive between, and therefore define, two opposing parallel planar surfaces.
